(19) United States
(12) Patent Application Publication
(10) Pub. No.: US 2025/0247680 A1
(43) Pub. Date: Jul. 31, 2025

(54) METHOD AND APPARATUS FOR SIDELINK BASED WIRELESS SENSING

(71) Applicant: LENOVO (BEIJING) LIMITED, Beijing (CN)

(72) Inventors: Lianhai WU, Beijing (CN); Jianfeng WANG, Beijing (CN); Luning LIU, Beijing (CN); Haiming WANG, Beijing (CN); Zhi YAN, Beijing (CN)

(21) Appl. No.: 19/111,145

(22) PCT Filed: Sep. 27, 2022
(86) PCT No.: PCT/CN2022/121738

§ 371 Date: Mar. 12, 2025

(51) Int. Cl. H04W 4/38; H04L 5/00; H04W 24/10; H04W 76/27; H04W 92/18

(52) U.S. Cl. CPC H04W 4/38; H04L 5/0048; H04W 24/10; H04W 76/27; H04W 92/18

(57) ABSTRACT

Embodiments of the present disclosure relate to a method and apparatus for sidelink based wireless sensing. According to some embodiments of the disclosure, a first user equipment (UE) may receive, from an upper layer of the first UE, a base station (BS) or a network node, a request to perform a PC5 based sensing; and perform the PC5 based sensing with a second UE in response to the request to perform the PC5 based sensing.

### TECHNICAL FIELD

Embodiments of the present disclosure generally relate to communication technology, and more particularly to sidelink based wireless sensing in a wireless communication system.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

Wireless sensing technologies aim to acquire information about a remote object and its characteristics without physically contacting it. The perception data of the object can be utilized for analysis, so that meaningful information about the object and its characteristics can be obtained. Radar is a widely used wireless sensing technology that uses radio waves to determine the distance (range), angle, or instantaneous linear velocity of objects. There are other sensing technologies including non-radio frequency (RF) sensors, which have been used in other areas, e.g., time-of-flight (ToF) cameras, accelerometers, gyroscopes and Lidars.

Integrated sensing and communication may refer to that the sensing capabilities are provided by the same wireless communication system and infrastructure (e.g., 5G NR) as used for communication, and the sensing information could be derived from RF-based and/or non-RF based sensors. In general, it could involve scenarios of communication assisted sensing, for example, where a communication system (e.g., 5G system) provides sensing services or sensing assisted communication, or when the sensing information related to the communication channel or environment is used to improve the communication service of the communication system itself, or the sensing information can be used to assist radio resource management, interference mitigation, beam management, mobility, etc.

Mobile operators can also play an important role in providing the integrated sensing and communication (e.g., based on the 5G system) to customers, including, for example, the management and control of the 5G-based sensing services.

Therefore, it is desirable to introduce the integrated sensing and communication into a wireless communication system such as a 5G system. It is further desirable to introduce sidelink based wireless sensing in a wireless communication system.

### SUMMARY

Some embodiments of the present disclosure provide a first user equipment (UE). The first UE may include: a transceiver; and a processor coupled to the transceiver. The processor may be configured to: receive, from an upper layer of the first UE, a base station (BS) or a network node, a request to perform a PC5 based sensing; and perform the PC5 based sensing with a second UE in response to the request to perform the PC5 based sensing.

In some embodiments of the present disclosure, the processor may be further configured to transmit a packet related with the PC5 based sensing to the second UE, and wherein transmitting the packet related with the PC5 based sensing comprises at least one of the following: transmitting, to the second UE, a packet data convergence protocol (PDCP) packet including an indication indicating that the packet is a sensing-related packet; or transmitting the packet related with the PC5 based sensing using a logical channel ID specific for a sensing-related packet.

In some embodiments of the present disclosure, the processor may be further configured to receive a sensing measurement report from the second UE, and wherein receiving the sensing measurement report comprises identifying a packet corresponding to the sensing measurement report as a sensing-related packet by at least one of the following: an indication in a PDCP format for the packet corresponding to the sensing measurement report indicates that the packet is a sensing-related packet; or a logical channel ID associated with the packet corresponding to the sensing measurement report is specific for a sensing-related packet.

In some embodiments of the present disclosure, the indication may be a service data unit (SDU) type specific for sensing-related packet or may be a reserved bit.

In some embodiments of the present disclosure, a priority of a logical channel for carrying the packet related with the PC5 based sensing or the sensing measurement report may be predefined, may be the same or different from that of a logical channel for carrying a non-sensing-related service, or may be determined according to a sensing service requirement.

In some embodiments of the present disclosure, a PC5 interface between the first UE and the second UE may include a sensing layer, which is located above a packet data convergence protocol (PDCP) layer, a service data adaptation protocol (SDAP) layer, a PC5-S layer, or a radio resource control (RRC) layer of the PC5 interface.

Some embodiments of the present disclosure provide a second user equipment (UE). The second UE may include: a transceiver; and a processor coupled to the transceiver. The processor may be configured to: receive a configuration for a PC5 based sensing from a first UE; and perform the PC5 based sensing with the first UE in response to receiving the configuration.

In some embodiments of the present disclosure, performing the PC5 based sensing may include at least one of the following: receiving a sensing reference signal (RS) from the first UE via a PC5 interface between the first UE and the second UE; transmitting a measurement result related to the sensing RS to the first UE; or transmitting a sensing RS to the first UE via the PC5 interface.

In some embodiments of the present disclosure, the processor may be further configured to establish a PC5 RRC connection between the first UE and the second UE, wherein the PC5 RRC connection is specific for the PC5 based sensing.

In some embodiments of the present disclosure, establishing the PC5 RRC connection may include receiving, from the first UE, a request to establish the PC5 RRC connection separated from an existing PC5 RRC connection between the first UE and the second UE. The request to establish the PC5 RRC connection may include an indication indicating the existing PC5 RRC connection. In some embodiments of the present disclosure, the indication may indicate a pair of a source ID and a destination ID of the existing PC5 RRC connection.

In some embodiments of the present disclosure, the PC5 RRC connection may be associated with a destination ID specific for the PC5 based sensing.

In some embodiments of the present disclosure, the processor may be further configured to perform at least one of the following: receive, from the first UE, area information indicating an area in which the PC5 based sensing is to be performed; or transmit a leaving indication to the first UE when the second UE leaves the area.

In some embodiments of the present disclosure, the processor may be further configured to receive, from the first UE, a release message to release a PC5 link between the first UE and the second UE in response to the leaving indication.

In some embodiments of the present disclosure, the processor may be further configured to receive, from the first UE, at least one trigger condition for a sensing measurement report. In some embodiments of the present disclosure, the at least one trigger condition may include at least one of the following: a pose change of an object of interest; a threshold for the number of objects of interest within a period; or a threshold for a channel quality change of a channel between the first UE and the second UE.

In some embodiments of the present disclosure, the processor may be further configured to identify a packet related with the PC5 based sensing as a sensing-related packet by at least one of the following: an indication in a packet data convergence protocol (PDCP) format for the packet related with the PC5 based sensing indicates that the packet is a sensing-related packet; or a logical channel ID associated with the packet related with the PC5 based sensing is specific for a sensing-related packet.

In some embodiments of the present disclosure, the processor may be further configured to transmit a sensing measurement report to the first UE. Transmitting the sensing measurement report may include at least one of the following: transmitting, to the first UE, a PDCP packet including an indication indicating that the packet is a sensing-related packet; or transmitting the sensing measurement report using a logical channel ID specific for a sensing-related packet.

In some embodiments of the present disclosure, the indication may be an SDU type specific for sensing-related packet or is a reserved bit.

In some embodiments of the present disclosure, a priority of a logical channel for carrying the packet related with the PC5 based sensing or the sensing measurement report may be predefined, may be the same or different from that of a logical channel for carrying a non-sensing-related service, or may be determined according to a sensing service requirement.

In some embodiments of the present disclosure, a PC5 interface between the first UE and the second UE may include a sensing layer, which is located above a packet data convergence protocol (PDCP) layer, a service data adaptation protocol (SDAP) layer, a PC5-S layer, or a radio resource control (RRC) layer of the PC5 interface.

Some embodiments of the present disclosure provide a network node. The network node may include: a transceiver; and a processor coupled to the transceiver. The processor may be configured to: transmit, to a base station (BS), a request for a PC5 based sensing service, wherein the request for the PC5 based sensing service indicates at least one of the following: area information indicating an area in which the PC5 based sensing is to be performed; an accuracy requirement for the PC5 based sensing service; a number of UEs assisting a target UE to perform the PC5 based sensing service; or ID(s) of the target UE; and receive, from the BS, a measurement result related to the PC5 based sensing service.

In some embodiments of the present disclosure, the network node may be an access and mobility management function (AMF). In some embodiments of the present disclosure, the network node may be a sensing function (SF), and the request for the PC5 based sensing service may be transmitted to the BS via the AMF.

In some embodiments of the present disclosure, the number of UEs may be indicated as a value range, or indicated as a minimum number of UEs.

Some embodiments of the present disclosure provide a method performed by a first UE. The method may include: receiving, from an upper layer of the first UE, a base station (BS) or a network node, a request to perform a PC5 based sensing; and performing the PC5 based sensing with a second UE in response to the request to perform the PC5 based sensing.

Some embodiments of the present disclosure provide a method performed by a second UE. The method may include: receiving a configuration for a PC5 based sensing from a first UE; and perform the PC5 based sensing with the first UE in response to receiving the configuration.

Some embodiments of the present disclosure provide a method performed by a network node. The method may include: transmitting, to a base station (BS), a request for a PC5 based sensing service, wherein the request for the PC5 based sensing service indicates at least one of the following: area information indicating an area in which the PC5 based sensing is to be performed; an accuracy requirement for the PC5 based sensing service; a number of UEs assisting a target UE to perform the PC5 based sensing service; or ID(s) of the target UE; and receiving, from the BS, a measurement result related to the PC5 based sensing service.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present application provide a technical solution for integrated sensing and communication and sidelink based sensing, which can facilitate and improve the implementation of various communication technologies.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a flow chart of an exemplary sensing procedure in accordance with some embodiments of the present disclosure;

FIG. 3 illustrates a schematic diagram of a wireless communication system in accordance with some embodiments of the present disclosure;

FIG. 4 illustrates a flow chart of an exemplary sidelink based sensing procedure in accordance with some embodiments of the present disclosure;

FIGS. 5A-5D illustrate example block diagrams of a protocol stack for sidelink based sensing in accordance with some embodiments of the present disclosure;

FIGS. 6-11 illustrate flow charts of exemplary sidelink based sensing procedures in accordance with some embodiments of the present disclosure; and

FIG. 12 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

With the development of communication technologies, a sensing function or sensing ability is proposed to be introduced to the 3GPP. Embodiments of the present disclosure provide solutions for enabling and improving integrated sensing and communication in a communication system. For example, in some embodiments of the present disclosure, a sensing related service may be requested and issued to entities in a communication system. A UE may perform sensing in response to the request. Enhancements on the interface between the UE, BS, and network node may be needed to enable the sensing function. Embodiments of the present disclosure provide signaling and procedures to enable and improve the integrated sensing and communication.

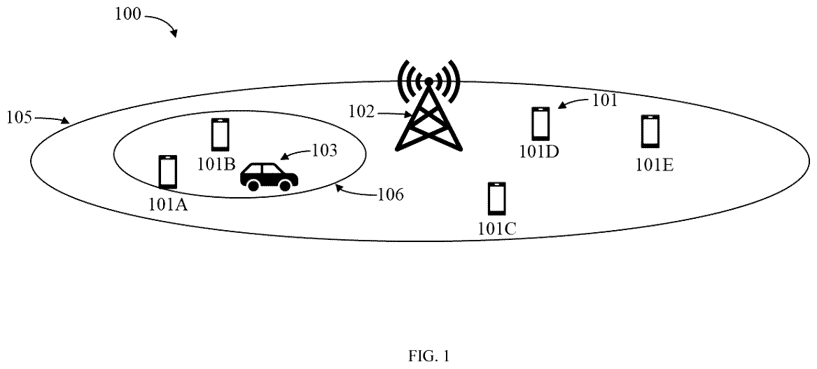

FIG. 1 illustrates a schematic diagram of a wireless communication system 100 in accordance with some embodiments of the present disclosure.

As shown in FIG. 1, a wireless communication system 100 may include a base station (e.g., BS 102) and some UEs 101 (e.g., UEs 101A-101E) located within the coverage area 105 of BS 102. Although a specific number of UE 101 and BS 102 is depicted in FIG. 1, it is contemplated that any number of UEs and BSs may be included in the wireless communication system 100.

UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, UE 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, UE 101 includes wearable devices, such as smart watches, fitness bands, optical head-mounted displays, or the like. Moreover, UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art. UE 101 may communicate with BS 102 via uplink (UL) communication signals.

UE 101 may be in one of the following states: an RRC-IDLE state, an RRC_CONNECTED state, or an RRC_INACTIVE state (also referred to as idle, connected, or inactive state, respectively), at a given time. The specific characteristics of the RRC-IDLE state, RRC_CONNECTED state, and RRC_INACTIVE state are defined in 3GPP specifications.

BS 102 may be distributed over a geographic region. In certain embodiments of the present disclosure, BS 102 may also be referred to as an access point, an access terminal, a base, a base unit, a macro cell, a Node-B, an evolved Node B (eNB), a gNB, a Home Node-B, a relay node, or a device, or described using other terminology used in the art. BS 102 is generally a part of a radio access network that may include one or more controllers communicably coupled to one or more corresponding BSs 102. BS 102 may communicate with UE 101 via downlink (DL) communication signals.

BS 102 may be in communication with a core network (not shown in FIG. 1). The core network (CN) may include a plurality of network nodes, such as a mobility management entity (MME) (not shown in FIG. 1) or an access and mobility management function (AMF) (not shown in FIG. 1). The CN may serve as gateways for the UEs to access a public switched telephone network (PSTN) and/or other networks (not shown in FIG. 1). In some embodiments of the present disclosure, the CN may further include a sensing function (SF) which may be in communication with, for example, the AMF or location management function (LMF).

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS 102 and UE 101 may communicate using other communication protocols, such as the IEEE 802.11 family of wireless communication protocols. Further, in some embodiments of the present disclosure, BS 102 and UE 101 may communicate over licensed spectrums, whereas in some other embodiments, BS 102 and UE 101 may communicate over unlicensed spectrums. The present disclosure is not intended to be limited to the implementation of any particular wireless communication system architecture or protocol.

In some embodiments of the present disclosure, BS 102 may want to sense a target (e.g., vehicle 103) in sensing area 106. For example, BS 102 may want to acquire the position, speed or lane occupying information of vehicle 103. This may also be referred to as “per-object sensing.” In some embodiments of the present disclosure, BS 102 may want to sense the radio environment of sensing area 106. This may also be referred to as “per-area sensing.” In some examples, BS 102 may select UEs 101A and 101B to perform the sensing since UEs 101A and 101B are within sensing area 106. UEs 101A and 101B may transmit corresponding signals to BS 102 for the sensing.

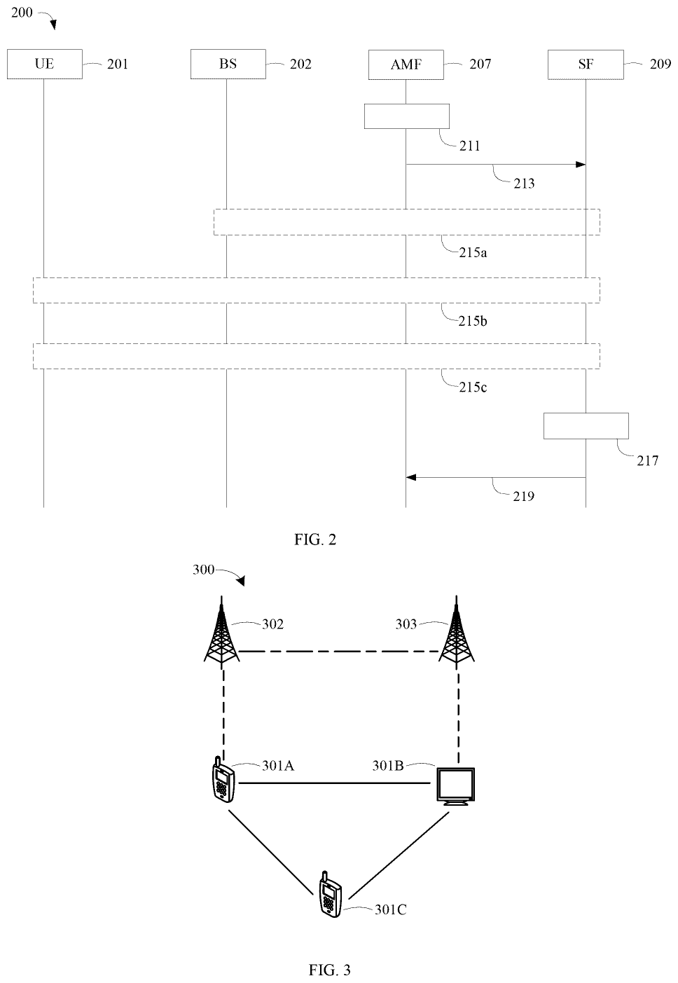

FIG. 2 illustrates a flow chart of an exemplary sensing procedure 200 in accordance with some embodiments of the present disclosure. Details described in all of the foregoing embodiments of the present disclosure are applicable for the embodiments shown in FIG. 2.

Procedure 200 illustrates a general sensing procedure. The procedure may be performed per a sensing area or per an object. Referring to FIG. 2, UE 201 and BS 202 may function as UE 101 and BS 102 shown in FIG. 1, respectively. AMF 207 may be in communication with SF 209 and BS 202. In some examples, SF 209 may or may not be in direct communication with BS 202. In some examples, SF 209 may be a part of an LMF.

In operation 211, AMF 207 may receive a sensing request from, for example, a sensing traffic requestor, for example, an application function (AF) or an internal network element (not shown in FIG. 2). In response to receiving the request, AMF 207 may select a suitable SF (e.g., SF 209) according to, for example, the information of the target area or object. In operation 213, AMF 207 may transmit the sensing request to SF 209. In some other embodiments of the present disclosure, the sensing traffic requestor may directly transmit the sensing request to SF 209, which may then select a suitable AMF.

In response to receiving the request, SF 209 may determine the sensing manner to be employed. For example, in operation 215a, SF 209 may determine to employ a RAN-based sensing sub-procedure. For example, in operation 215b, SF 209 may determine to employ a UE-assisted sensing sub-procedure. For example, in operation 215c, SF 209 may determine to employ a UE-based sensing sub-procedure. It should be noted that the sensing sub-procedure may involve more than one BS and/or more than one UE.

In some embodiments of the present disclosure, when BS 202 and/or UE 201 are capable of performing a sensing operation(s), a sensing response carrying a success indication may be transmitted to SF 209; otherwise, a sensing response carrying a failure indication may be transmitted to SF 209.

In operation 217, SF 209 may perform a sensing calculation based on the sensing measurements from BS 202 and may obtain a sensing result. In operation 219, SF 209 may transmit the sensing result to AMF 207. AMF 207 may transmit the sensing result to the sensing traffic requestor (e.g., the AF). In some other embodiments of the present disclosure, SF 209 may transmit the sensing result to the sensing traffic requestor without AMF 207.

It should be appreciated by persons skilled in the art that the sequence of the operations in exemplary procedure 200 may be changed and some of the operations in exemplary procedure 200 may be eliminated or modified, without departing from the spirit and scope of the disclosure.

Although embodiments of the present disclosure are described with respect to network nodes such as the AMF and SF, it is contemplated that other network nodes may be employed to perform the operations of the AMF and SF.

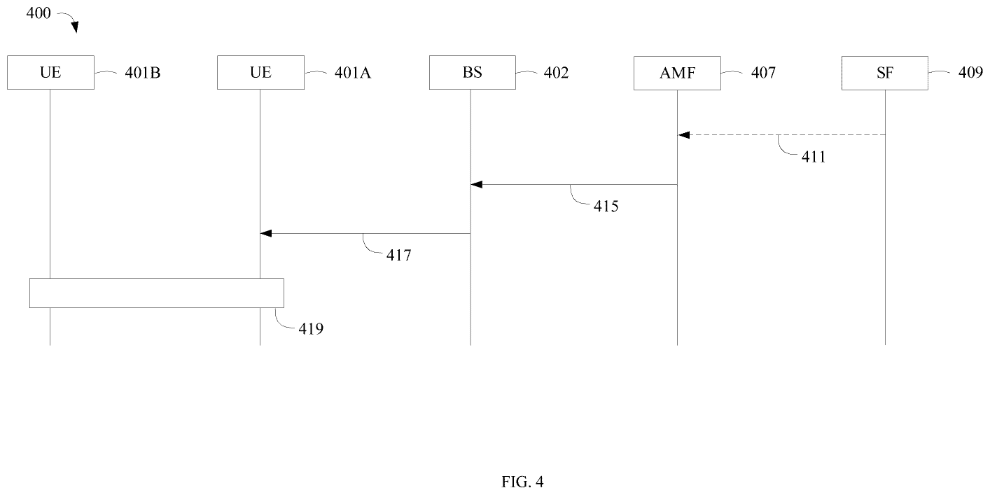

FIG. 3 illustrates a schematic diagram of wireless communication system 300 in accordance with some embodiments of the present disclosure.

As shown in FIG. 3, the wireless communication system 300 may support sidelink communications. Sidelink communication supports UE-to-UE direct communication. In the context of the present disclosure, sidelink communications may be categorized according to the wireless communication technologies adopted. For example, sidelink communication may include NR sidelink communication and V2X sidelink communication.

NR sidelink communications (e.g., specified in 3GPP specification TS 38.311) may refer to access stratum (AS) functionality enabling at least vehicle-to-everything (V2X) communications as defined in 3GPP specification TS 23.287 between neighboring UEs, using NR technology but not traversing any network node. V2X sidelink communications (e.g., specified in 3GPP specification TS 36.311) may refer to AS functionality enabling V2X communications as defined in 3GPP specification TS 23.285 between neighboring UEs, using evolved-universal mobile telecommunication system (UMTS) terrestrial radio access (UTRA) (E-UTRA) technology, but not traversing any network node. However, if not being specified, “sidelink communications” may refer to NR sidelink communications, V2X sidelink communications, or any sidelink communications adopting other wireless communication technologies.

Referring to FIG. 3, the wireless communication system 300 may include some base stations (e.g., BS 302 and BS 303) and some UEs (e.g., UE 301A, UE 301B, and UE 301C). BS 302 and BS 303 may function as BS 102 shown in FIG. 1, and UE 301A, UE 301B, and UE 301C may function as UE 101 shown in FIG. 1. Although a specific number of UEs and BSs is depicted in FIG. 3, it is contemplated that any number of UEs and BSs may be included in the wireless communication system 300.

In the example of FIG. 3, the BS 302 and the BS 303 may be included in a next generation radio access network (NG-RAN). In some embodiments of the present disclosure, the BS 302 may be a gNB and the BS 303 may be an ng-eNB.

The UE 301A and UE 301B may be in-coverage (e.g., inside the NG-RAN). For example, as shown in FIG. 3, the UE 301A may be within the coverage of BS 302, and the UE 301B may be within the coverage of BS 303. The UE 301C may be out-of-coverage (e.g., outside the coverage of the NG-RAN). For example, as shown in FIG. 3, the UE 301C may be outside the coverage of any BS, for example, both the BS 302 and BS 303. The UE 301A and UE 301B may respectively connect to the BS 302 and BS 303 via a network interface, for example, the Uu interface as specified in 3GPP standard documents. The control plane protocol stack in the Uu interface may include a radio resource control (RRC) layer, which may be referred to as a Uu RRC. The link established between a UE (e.g., UE 301A) and a BS (e.g., BS 302) may be referred to as a Uu link. The BS 302 and BS 303 may be connected to each other via a network interface, for example, the Xn interface as specified in 3GPP standard documents. The UE 301A, UE 301B, and UE 301C may be connected to each other respectively via, for example, a PC5 interface as specified in 3GPP standard documents. The control plane protocol stack in the PC5 interface may include a radio resource control (RRC) layer, which may be referred to as a PC5 RRC. The link established between two UEs (e.g., UE 301A and UE 301B) may be referred to as a PC5 link.

Support for V2X services via the PC5 interface can be provided by, for example, NR sidelink communication and/or V2X sidelink communication. NR sidelink communication can support one of the following three types of transmission modes for a pair of a source Layer-2 identity and a destination Layer-2 identity: unicast transmission, groupcast transmission, and broadcast transmission. Sidelink communication transmission and reception over the PC5 interface are supported when the UE is either in-coverage or out-of-coverage. For example, the UE 301A, which is within the coverage of the BS 302, can perform sidelink transmission and reception (e.g., sidelink unicast transmission, sidelink groupcast transmission, or sidelink broadcast transmission) over a PC5 interface. The UE 301C, which is outside the coverage of both the BS 302 and BS 303, can also perform sidelink transmission and reception over a PC5 interface.

A UE which supports sidelink communication and/or V2X communication may be referred to as a V2X UE. A V2X UE may be a cell phone, a vehicle, a roadmap device, a computer, a laptop, an IoT (internet of things) device or other type of device in accordance with some other embodiments of the present disclosure.

In some embodiments of the present disclosure, a sensing functionality may be implemented based on a sidelink. For example, a UE can assist another UE to perform a sensing related service. The two UE may be either in-coverage or out-of-coverage. Various issues need to be solved during such sidelink based sensing procedure.

For example, the impact on the PC5 RRC connection between UEs when a sidelink based sensing is performed should be considered. In some embodiments of the present disclosure, a PC5 RRC connection dedicated for sensing may be established. Enhancement on such embodiments should be considered. For example, the impact on the AS layer should also be considered. For example, it would be beneficial if the AS layer is aware that sensing related information is transmitted. For example, new UE behaviors may be required when an assisted UE leaves the area in which the sidelink based sensing is performed. For example, solutions for triggering a sensing measurement report are needed. For example, the impact on the protocol stack should also be considered.

Embodiments of the present disclosure provide solutions for sidelink based sensing (also referred to as “PC5 based sensing”), which can at least handling the above issues. More details on the embodiments of the present disclosure will be illustrated in the following text in combination with the appended drawings.

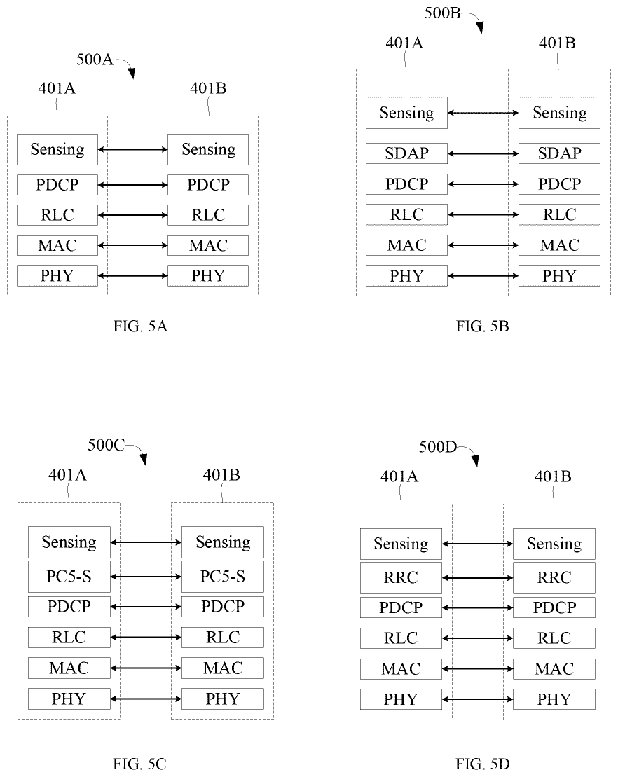

FIG. 4 illustrates a flow chart of an exemplary procedure 400 for sidelink based sensing in accordance with some embodiments of the present disclosure. Details described in all of the foregoing embodiments of the present disclosure are applicable for the embodiments shown in FIG. 4.

Referring to FIG. 4, UE 401A and UE 401B may function as the UEs shown in FIGS. 1-3, and BS 402 may function as the BSs shown in FIGS. 1-3. AMF 407 may be in communication with SF 409 and BS 402. In some examples, SF 409 may or may not be in direct communication with BS 402. AMF 407 and SF 409 may respectively function as AMF 207 and SF 209 shown in FIG. 2.

In operation 411 (denoted by dotted arrow as an option), SF 409 may transmit a request for a PC5 based sensing service to AMF 407. In some embodiments, the request for the PC5 based sensing service may indicate at least one of the following: area information indicating an area in which the PC5 based sensing is to be performed; an accuracy requirement for the PC5 based sensing service; a number of UEs (also referred to as “assisted UEs”) assisting a target UE to perform the PC5 based sensing service; ID(s) of the target UE(s); or one or more sensing methods expected to be used. In some examples, the target UE may be referred to as a UE which is expected to performing the sensing task.

In some examples, the area information may also be referred to “range information.”In some embodiments of the present disclosure, the area information may indicate an ID of the target area or a list of cells covering the target area. In some embodiments of the present disclosure, the area information may indicate a threshold for an area or range between the target UE and the assisted UE. For example, it is expected that an assisted UE assists the sensing when the distance between the assisted UE and the target UE is within the threshold.

The number of assisted UEs (denoted as number #1) may refer to the number of UEs which is expected to perform measurement for the PC5 based sensing. In some embodiments of the present disclosure, number #1 may be indicated as a value range (e.g., from the maximum value to the minimum) for a minimum number of UEs. The indicated UE ID(s) may be layer-2 UE ID(s).

In response to receiving the request for the PC5 based sensing service, AMF 407 may transmit the request to BS 402 in operation 415. AMF 407 may transmit such request to one or more BSs.

Although in the example of FIG. 4, SF 409 determines the parameters in the request for the PC5 based sensing service and transmits the request to AMF 407, it is contemplated that AMF 407 may determine the parameters in some other embodiments of the present disclosure. For example, operation 411 may be omitted. AMF 407 may determine the information in the request for a PC5 based sensing service as defined above and then transmit the request to one or more BSs. It is also contemplated that BS 402 may determine the parameters in yet other embodiments of the present disclosure. For example, operations 411 and 415 may be omitted.

In some embodiments of the present disclosure, in response to receiving the request from AMF 407, BS 402 may, in operation 417, transmit a request to perform a PC5 based sensing to a UE (e.g., UE 401A) with the indicated UE ID (such UE may also be referred to a target UE). In some examples, the UE ID may be the cell-radio network temporary identifier (C-RNTI) or a Layer-2 ID. In some embodiments of the present disclosure, BS 402 may select a target UE(s) to performing the sensing task based on the request.

In some embodiments of the present disclosure, the request may include the configuration for the PC5 based sensing. In some examples, the existence of such configuration may suggest the request to perform sensing.

For example, in the case that UE 401A is in a connected state, BS 402 may transmit a reconfiguration message or another message to UE 401A directly. The reconfiguration message may include the configuration for the PC5 based sensing. For example, the configuration may include configuration of PC5 based sensing reference signal (RS), report configuration, or both. For example, in the case that UE 401A is in an idle or inactive state, BS 402 may first transmit a paging message to UE 401A. In response to receiving the paging message, UE 401A may transit to a connected state.

In some embodiments of the present disclosure, the target UE may be expected to select some assisted UEs to assisting the completion of the PC5 based sensing. For example, when number #1 is included in the request, the target UE (e.g., UE 401A) is expected to select one or more assisted UEs to assist the PC5 based sensing based on number #1.

In response to receiving the request to perform the PC5 based sensing, UE 401A may perform the PC5 based sensing with another UE.

For example, in operation 419, UE 401A may select one or more UEs (e.g., UE 401B) to assist the completion of the sensing service via a discovery procedure. In some embodiments, UE 401A may transmit the discovery message including sensing related information. The sensing related information may indicate at least the following: a cause value related with PC5 based sensing, the configuration for PC5 based sensing RS, the capability related to PC5 based sensing technology (for example, a receiving UE is capable of performing the sensing technology, such as transmitting sensing RS via the PC5 link), or the area (or range) information. The definition of the area information as described above may apply here. In some examples, the range/area information may be configured by the network (e.g., a BS or a network node such as an AMF or an SF). In some examples, the range/area information may be determined by the target UE.

After discovering the UE(s) for assisting the PC5 based sensing service, UE 401A may establish a PC5 RRC connection with the selected UE(s). For example, in the case that UE 401A selects a UE which has no existing PC5 RRC connection with UE 401A, UE 401A may establish a PC5 RRC connection with the selected UE. In some embodiments, the PC5 RRC connection may be specific for the PC5 based sensing. For example, UE 401A may establish a PC5 RRC connection specific for the PC5 based sensing with UE 401B in response to the request to perform the PC5 based sensing.

In the case that UE 401A selects a UE which has an existing PC5 RRC connection (also referred to as “original PC5 RRC connection”) with the UE 401A, a separate PC5 RRC connection (also referred to as “new PC5 RRC connection”) may be established for the PC5 based sensing. In some embodiments, the separate PC5 RRC connection may be specific for the PC5 based sensing. For example, UE 401A may transmit, to UE 401B, a request to establish the PC5 RRC connection separated from the existing PC5 RRC connection between UE 401A and UE 401B. In some embodiments, the request to establish the PC5RRC connection may include an indication indicating the existing PC5 RRC connection. In some embodiments, the indication may include a pair of a source ID and a destination ID of the existing PC5 RRC connection. The source ID may denote an ID of UE 401A. Based on the indication, UE 401B may be aware of the existing PC5 RRC connection between UE 401A and UE 401B and can identify the same target UE.

In some embodiments, the determination for a PC5 radio link failure (RLF), which may be based on, for example, the channel quality can be reused among the two (i.e., original and new) PC5 RRC connections.

In some embodiments, the new PC5 RRC connection may be associated with a destination ID specific for the PC5 based sensing. For example, in the case of two PC5 RRC connections being established, a separate destination ID (e.g., a destination L2 ID) may be allocated for the new PC5 RRC connection for the sensing purpose. The destination ID may be allocated by a BS (e.g., BS 402) or a UE (e.g., UE 401A).

In some embodiments, a sidelink-UE-information (SUI) message may include an indication to indicate the destination L2 ID for which the transmit (TX) resource request and allocation from the network are concerned for sensing.

Using a L2 destination ID dedicated for sensing can advantageously facilitate the differentiation of sensing transmission from other transmissions. Moreover, it can also facilitate the determination of whether other data can be multiplexed with the sensing data since only the data of the same destination can be multiplexed in the same MAC protocol data unit (PDU).

In some other embodiments of the present disclosure, UE 401A and UE 401B may use the existing PC5 RRC connection for the PC5 based sensing. Solutions for identifying the sensing transmission in such embodiments will be described later.

In some embodiments of the present disclosure, after the PC5 RRC connection is established, UE 401A may transmit a packet related with the PC5 based sensing (e.g., a configuration for the PC5 based sensing) to UE 401B.

In some embodiments, the packet related with the PC5 based sensing may be generated by a sensing layer of UE 401A. After the sensing layer generates the configuration, it is delivered to a lower layer(s), which will transmit it to the peer UE (e.g., UE 401B) via the PC5 link.

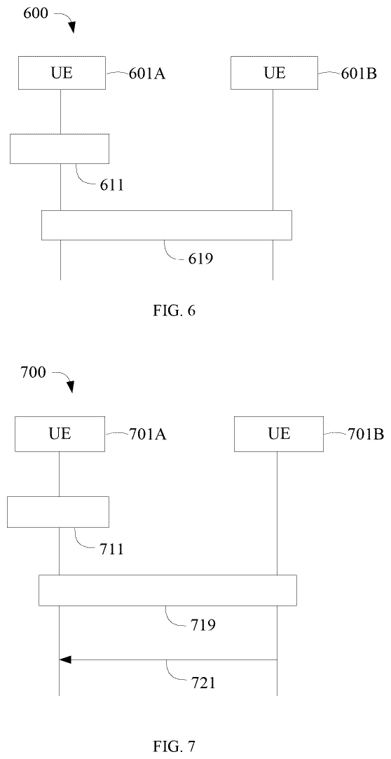

FIGS. 5A-5D illustrate example block diagrams of a protocol stack for UEs (e.g., UE 401A and UE 401B in FIG. 4) performing the PC5 based sensing in accordance with some embodiments of the present disclosure. For example, UE 401A and UE 401B in FIG. 4 may employ one of protocol stack 500A-500D for a PC5 transmission(s) related to a sensing layer.

FIG. 5A shows a user plane (UP)/control plane (CP) based solution. The UP or CP protocol stack of UE 401A or UE 401B may include a sensing layer, a packet data convergence protocol (PDCP) layer, a radio link control (RLC) layer, a medium access control (MAC) layer, and a physical (PHY) layer. The sensing layer is placed above the PDCP layer at the PC5 interface. Sensing related data can be transmitted via a sidelink data radio bearer (SL-DRB) or a sidelink signaling radio bearer (SL-SRB).

FIG. 5B shows a UP based solution. The protocol stack of UE 401A or UE 401B may include a sensing layer, a service data adaptation protocol (SDAP) layer, a PDCP layer, an RLC layer, an MAC layer, and a PHY layer. The sensing layer is placed above the SDAP layer at the PC5 interface. Sensing related data can be transmitted via an SL-DRB.

FIG. 5C shows a CP based solution. The protocol stack of UE 401A or UE 401B may include a sensing layer, a PC5-S layer, a PDCP layer, an RLC layer, an MAC layer, and a PHY layer. The sensing layer is placed above the PC5-S layer at the PC5 interface. Sensing related data can be transmitted via an SL-DRB.

In some embodiments, an SL-DRB (e.g., SL-SRB2 as defined in 3GPP standard documents) may be used to transmit the PC5-S messages (which are protected) after the PC5-S security has been established. Sensing related packets can be transmitted via SL-SRB2 or an SL-SRB specific for PC5 based sensing.

FIG. 5D shows a CP based solution. The protocol stack of UE 401A or UE 401B may include a sensing layer, an RRC layer, a PDCP layer, an RLC layer, an MAC layer, and a PHY layer. The sensing layer is placed above the RRC layer at the PC5 interface. Sensing related data can be transmitted via an SL-DRB.

In some embodiments, an SL-DRB (e.g., SL-SRB3 as defined in 3GPP standard documents) may be used to transmit the PC5-RRC signaling or message, which may be protected and only sent after the PC5-S security has been established. Sensing related packets can be transmitted via SL-SRB3 or an SL-SRB specific for PC5 based sensing.

It should be noted that the protocol stacks shown in FIGS. 5A-5D are only for illustrative purposes, and other protocol stacks may also be applicable.

In procedure 400, the network (e.g., a BS or a network node such as an AMF or an SF) may trigger the PC5 based sensing service. The procedure 400 may be performed when, for example, the target UE is in-coverage. As will be described later, a UE may trigger a PC5 based sensing service.

It should be appreciated by persons skilled in the art that the sequence of the operations in exemplary procedure 400 may be changed and some of the operations in exemplary procedure 400 may be eliminated or modified, without departing from the spirit and scope of the disclosure.

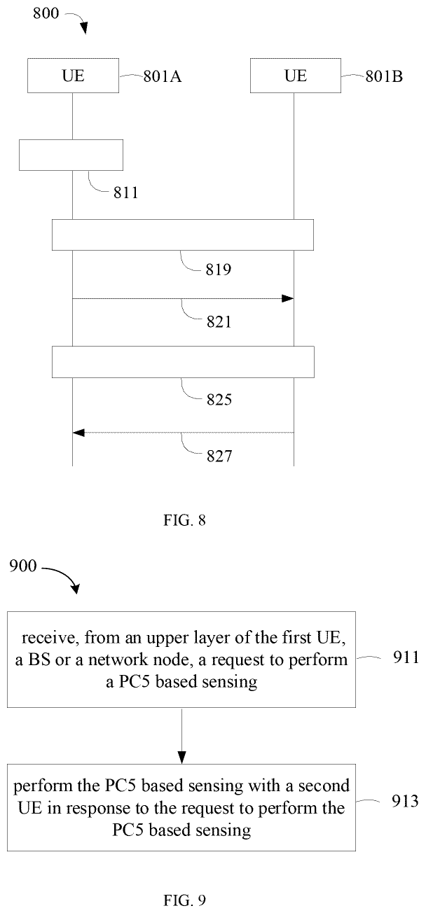

FIG. 6 illustrates a flow chart of an exemplary procedure 600 for sidelink based sensing in accordance with some embodiments of the present disclosure. Details described in all of the foregoing embodiments of the present disclosure are applicable for the embodiments shown in FIG. 6.

Referring to FIG. 6, UE 601A and UE 601B may function as the UEs shown in FIGS. 1-5D. In some embodiments, UE 601A and UE 601B may in-coverage or out-of-coverage. In exemplary procedure 600, a UE may trigger a PC5 based sensing service.

In operation 611, an upper layer (e.g., a sensing layer) of UE 601A may inform its AS layer (e.g., an RRC layer) to perform a PC5 based sensing service. For example, the upper layer may transmit a request to perform a PC5 based sensing to the AS layer. The descriptions with respect to the requests in operations 411-417 in FIG. 4 may apply here. For example, the request may indicate at least one of the following: area information indicating an area in which the PC5 based sensing is to be performed; an accuracy requirement for the PC5 based sensing service; a number of UEs assisting UE 601A to perform the PC5 based sensing service; or one or more sensing methods expected to be used. The descriptions of the area information with respect to FIG. 4 may apply here. The descriptions of number #1 with respect to FIG. 4 may be applied to the number of UEs assisting UE 601A. For example, the number of UEs assisting UE 601A may be indicated as a value range (e.g., from the maximum value to the minimum) for a minimum number of UEs.

In response to receiving the request to perform the PC5 based sensing from the upper layer, UE 601A may perform the PC5 based sensing with another UE.

For example, in operation 619, UE 601A may select one or more UEs (e.g., UE 601B) to assist the completion of the sensing service via a discovery procedure. The descriptions of operation 419 in FIG. 4 may be applied to operation 619.

For example, in some embodiments, UE 601A may transmit the discovery message including sensing related information. The sensing related information may indicate at least the following: a cause value related with PC5 based sensing, the configuration for PC5 based sensing RS, the capability related to PC5 based sensing technology (for example, a receiving UE is capable of performing the sensing technology, such as transmitting sensing RS via the PC5 link), or the area (or range) information.

After discovering the UE(s) for assisting the PC5 based sensing service, UE 601A may establish a PC5 RRC connection with the selected UE(s). For example, in the case that UE 601A selects a UE which has no existing PC5 RRC connection with UE 601A, UE 601A may establish a PC5 RRC connection with the selected UE. In some embodiments, the PC5 RRC connection may be specific for the PC5 based sensing. For example, UE 601A may establish a PC5 RRC connection specific for the PC5 based sensing with UE 601B in response to the request to perform the PC5 based sensing.

In the case that UE 601A selects a UE which has an existing PC5 RRC connection (original PC5 RRC connection) with the UE 601A, a separate PC5 RRC connection (new PC5 RRC connection) may be established for the PC5 based sensing. In some embodiments, the separate PC5 RRC connection may be specific for the PC5 based sensing. For example, UE 601A may transmit, to UE 601B, a request to establish the PC5 RRC connection separated from the existing PC5 RRC connection between UE 601A and UE 601B. In some embodiments, the request to establish the PC5 RRC connection may include an indication indicating the existing PC5 RRC connection. In some embodiments, the indication may include a pair of a source ID and a destination ID of the existing PC5 RRC connection. The source ID may denote an ID of UE 601A. Based on the indication, UE 601B may be aware of the existing PC5 RRC connection between UE 601A and UE 601B and can identify the same target UE.

In some embodiments, the determination for a PC5 RLF can be reused among the two (i.e., original and new) PC5 RRC connections.

In some embodiments, the new PC5 RRC connection may be associated with a destination ID specific for the PC5 based sensing. For example, in the case of two PC5 RRC connections being established, a separate destination ID (e.g., a destination L2 ID) may be allocated for the new PC5 RRC connection for the sensing purpose. The destination ID may be allocated by UE 601A.

In some embodiments, the SUI message may include an indication to indicate the destination L2 ID for which the TX resource request and allocation from the network are concerned for sensing.

In some embodiments of the present disclosure, after the PC5 RRC connection is established, UE 601A may transmit a packet related with the PC5 based sensing (e.g., a configuration for the PC5 based sensing) to UE 601B.

In some embodiments, the packet related with the PC5 based sensing may be generated by a sensing layer of UE 601A. After the sensing layer generates the configuration, it is delivered to a lower layer(s), which will transmit it to the peer UE (e.g., UE 601B) via the PC5 link.

In some embodiments, the protocol stacks shown in FIGS. 5A-5D or other protocol stacks may be applied to UE 601A and UE 601B.

It should be appreciated by persons skilled in the art that the sequence of the operations in exemplary procedure 600 may be changed and some of the operations in exemplary procedure 600 may be eliminated or modified, without departing from the spirit and scope of the disclosure.

FIG. 7 illustrates a flow chart of an exemplary procedure 700 for sidelink based sensing in accordance with some embodiments of the present disclosure. Details described in all of the foregoing embodiments of the present disclosure are applicable for the embodiments shown in FIG. 7.

Referring to FIG. 7, UE 701A and UE 701B may function as the UEs shown in FIGS. 1-6. In some embodiments, UE 701A and UE 701B may in-coverage or out-of-coverage.

In operation 711, an upper layer (e.g., a sensing layer) of UE 701A, a BS (e.g., the serving BS of UE 701A), or a network node (e.g., an AMF or SF) may request UE 701A to perform a PC5 based sensing service. For example, UE 701A may receive a request to perform a PC5 based sensing. The descriptions with respect to the requests in operations 411-417 in FIG. 4 and in operation 611 in FIG. 6 may apply here. For example, the request to perform the PC5 based sensing may indicate at least one of the following: area information indicating an area in which the PC5 based sensing is to be performed; an accuracy requirement for the PC5 based sensing service; a number of UEs assisting UE 701A to perform the PC5 based sensing service; or one or more sensing methods expected to be used. For example, the number of UEs assisting UE 701A may be indicated as a value range (e.g., from the maximum value to the minimum) for a minimum number of UEs.

In response to receiving the request to perform the PC5 based sensing, UE 701A may perform the PC5 based sensing with another UE.

For example, in operation 719, UE 701A may select one or more UEs (e.g., UE 701B) to assist the completion of the sensing service via a discovery procedure. The descriptions of operation 419 in FIG. 4 and operation 619 in FIG. 6 may be applied to operation 719.

For example, in some embodiments, UE 701A may transmit the discovery message including sensing related information. The sensing related information may indicate at least the following: a cause value related with PC5 based sensing, the configuration for PC5 based sensing RS, the capability related to PC5 based sensing technology (for example, a receiving UE is capable of performing the sensing technology, such as transmitting sensing RS via the PC5 link), or the area (or range) information.

After discovering the UE(s) for assisting the PC5 based sensing service, UE 701A may establish a PC5 RRC connection with the selected UE(s). In some embodiments of the present disclosure, after the PC5 RRC connection is established, UE 701A may transmit a packet related with the PC5 based sensing (e.g., a configuration for the PC5 based sensing) to UE 701B. In some embodiments, the area (or range) information indicating an area in which the PC5 based sensing is to be performed may be transmitted to UE 701B.

In response to receiving the configuration, UE 701B may perform the PC5 based sensing with UE 701A. In some embodiments of the present disclosure, a PC5 based sensing service may include at least one of the following: a target UE transmits a sensing RS to an assisted UE via a PC5 interface; the assisted UE reports the measurement result to the target UE after receiving the sensing RS via the PC5 interface; or the target UE can request the assisted UE to transmit a sensing RS via the PC5 interface.

From the perspective of UE 701A (i.e., target UE), performing the PC5 based sensing may include at least one of the following: transmitting a sensing RS to UE 701B via the PC5 interface between UE 701A and UE 701B; receiving a measurement result related to the sensing RS from UE 701B; or receiving a sensing RS from UE 701B via the PC5interface.

From the perspective of UE 701B (i.e., assisted UE), performing the PC5 based sensing may include at least one of the following: receiving a sensing RS from UE 701A via the PC5 interface between UE 701A and UE 701B; transmitting a measurement result related to the sensing RS to UE 701A; or transmitting a sensing RS to UE 701A via the PC5 interface.

In some embodiments, UE 701B may report the sensing measurement result (e.g., transmitting a sensing measurement report) to UE 701A according to at least one trigger condition. The at least one trigger condition may be configured by UE 701A. For example, UE 701A may transmit at least one trigger condition for the sensing measurement report to UE 701B. In some examples, the trigger condition may be included in the configuration for the PC5 based sensing.

In some embodiments of the present disclosure, the at least one trigger condition may include at least one of the following: a pose change of an object of interest (e.g., stand up or sit down, or change in the hand location); a threshold for the number of objects of interest within a period; or a threshold for a channel quality (e.g., reference signal received power (RSRP)) change of a channel between UE 701A and UE 701B.

For example, when the purpose of a sensing service is to catch the change of a pose change (e.g., stand up or sit down, or change in the hand location), the “pose change” trigger condition may be employed. For example, when the purpose of a sensing service is to report the density of an object of interest, the “threshold for the number of objects of interest” trigger condition may be employed. For instance, the threshold for the number of objects of interest may refer to the number of cars in a transport case. For example, when the purpose of a sensing service is to report the density of rain (e.g., whether there is a heavy rain or a light rain), the “threshold for the channel quality change” trigger condition may be employed.

In some embodiments of the present disclosure, UE 701B may leave the area in which the PC5 based sensing should be performed. UE 701B may transmit a leaving indication to UE 701A in operation 721 when UE 701B leaves the area. For example, the leaving indication may be transmitted via a notification message.

In response to receiving the leaving indication or the notification message, UE 701A may determine whether to release the PC5 link between UE 701A and UE 701B. In the case that UE 701A determines to stop the sensing service with UE 701B, UE 701A may transmit a release message to UE 701B to release the PC5 link between UE 701A and UE 701B.

It should be appreciated by persons skilled in the art that the sequence of the operations in exemplary procedure 700 may be changed and some of the operations in exemplary procedure 700 may be eliminated or modified, without departing from the spirit and scope of the disclosure.

FIG. 8 illustrates a flow chart of an exemplary procedure 800 for sidelink based sensing in accordance with some embodiments of the present disclosure. Details described in all of the foregoing embodiments of the present disclosure are applicable for the embodiments shown in FIG. 8.

Referring to FIG. 8, UE 801A and UE 801B may function as the UEs shown in FIGS. 1-7. In some embodiments, UE 801A and UE 801B may in-coverage or out-of-coverage.

In operation 811, an upper layer (e.g., a sensing layer) of UE 801A, a BS (e.g., the serving BS of UE 801A), or a network node (e.g., an AMF or SF) may request UE 801A to perform a PC5 based sensing service. For example, UE 801A may receive a request to perform a PC5 based sensing. The descriptions with respect to the requests in operations 411-417 in FIG. 4, in operation 611 in FIG. 6, and in operation 711 in FIG. 7 may apply here.

For example, the request to perform the PC5 based sensing may indicate at least one of the following: area information indicating an area in which the PC5 based sensing is to be performed; an accuracy requirement for the PC5 based sensing service; a number of UEs assisting UE 801A to perform the PC5 based sensing service; or one or more sensing methods expected to be used. For example, the number of UEs assisting UE 801A may be indicated as a value range (e.g., from the maximum value to the minimum) for a minimum number of UEs.

In response to receiving the request to perform the PC5 based sensing, UE 801A may perform the PC5 based sensing with another UE.

For example, in operation 819, UE 801A may select one or more UEs (e.g., UE 801B) to assist the completion of the sensing service via a discovery procedure. The descriptions of operation 419 in FIG. 4, operation 619 in FIG. 6, and operation 719 in FIG. 7 may be applied to operation 819.

For example, in some embodiments, UE 801A may transmit the discovery message including sensing related information. The sensing related information may indicate at least the following: a cause value related with PC5 based sensing, the configuration for PC5 based sensing RS, the capability related to PC5 based sensing technology (for example, a receiving UE is capable of performing the sensing technology, such as transmitting sensing RS via the PC5 link), or the area (or range) information.

After discovering the UE(s) for assisting the PC5 based sensing service, UE 801A may establish a PC5 RRC connection with the selected UE(s). In some embodiments of the present disclosure, after the PC5 RRC connection is established, UE 801A may, in operation 821, transmit a packet related with the PC5 based sensing (e.g., a configuration for the PC5 based sensing) to UE 801B. In some embodiments, the area (or range) information indicating an area in which the PC5 based sensing is to be performed may be transmitted to UE 801B.

In some embodiments of the present disclosure, the PDCP format may include an indication indicating that the packet is a sensing-related packet. For example, a service data unit (SDU) type specific for sensing-related packet may be used to indicate that the PDCP PDU is for sensing. Alternative, a reserved bit (e.g., ‘R’ bit) in the PDCP format may be used for indicate that the PDCP PDU is for sensing. Such indication may be indicated by the sensing layer. For example, the sensing layer may indicate whether a packet associated with sensing is delivered to the PDCP layer.

In some embodiments of the present disclosure, a logical channel ID (LCID) specific for a sensing-related packet may be is reserved in the MAC layer. For example, an LCID specific for a sensing-related packet may be used for transmitting the packet related with the PC5 based sensing.

For example, UE 801A may transmit, to UE 801B, a PDCP packet including an indication indicating that the packet is a sensing-related packet. For example, UE 801A may transmit, to UE 801B, a packet related with the PC5 based sensing using an LCID specific for a sensing-related packet.

UE 801B may identify a packet as a sensing-related packet by at least one of the following: an indication in a PDCP format for the packet indicates that the packet is a sensing-related packet; or an LCID associated with the packet is specific for a sensing-related packet.

It would be advantage to know the (relative) priority of the sensing data, since it can help us to assign an AS layer priority to a sensing message (e.g., for logical channel prioritization (LCP) and UL/SL prioritization).

In some embodiments of the present disclosure, a priority of a logical channel for carrying the sensing message (e.g., a packet related with the PC5 based sensing or the sensing measurement report) may be predefined, may be the same or different from that of a logical channel for carrying a non-sensing-related service, or may be determined according to a sensing service requirement. For example, the logical channel priority of a sensing message may be the same as the current sidelink (SL) SRBs, for example, setting as priority value=1. For example, the logical channel priority of a sensing message may be different from the current SL SRB, for example, setting as priority value>1. For example, various priority values can be set for the logical channel of a sensing message, depending on the requirement for the sensing service. A mapping table may be maintained at the target UE (e.g., UE 801A) for determining the suitable priority value for a sensing message associated with a certain sensing service.

In operation 825, UE 801B may perform the PC5 based sensing with UE 801A based on the configuration for the PC5 based sensing.

From the perspective of UE 801A (i.e., target UE), performing the PC5 based sensing may include at least one of the following: transmitting a sensing RS to UE 801B via the PC5 interface between UE 801A and UE 801B; receiving a measurement result related to the sensing RS from UE 801B; or receiving a sensing RS from UE 801B via the PC5 interface.

From the perspective of UE 801B (i.e., assisted UE), performing the PC5 based sensing may include at least one of the following: receiving a sensing RS from UE 801A via the PC5 interface between UE 801A and UE 801B; transmitting a measurement result related to the sensing RS to UE 801A; or transmitting a sensing RS to UE 801A via the PC5 interface.

For example, in operation 827, UE 801B may transmit a sensing measurement report to UE 801A. Similarly as described above, in some embodiments of the present disclosure, the PDCP packet corresponding to the sensing measurement report may include an indication indicating that the packet is a sensing-related packet. For example, a service data unit (SDU) type specific for sensing-related packet may be used to indicate that the PDCP PDU is for sensing. Alternative, a reserved bit (e.g., ‘R’ bit) in the PDCP format may be used for indicate that the PDCP PDU is for sensing. Such indication may be indicated by the sensing layer. In some embodiments of the present disclosure, an LCID specific for a sensing-related packet may be used for transmitting the packet.

For example, UE 801B may transmit, to UE 801A, a PDCP packet corresponding to the sensing measurement report including an indication indicating that the packet is a sensing-related packet. For example, UE 801B may transmit, to UE 801A, the sensing measurement report using a logical channel ID specific for a sensing-related packet.

For example, UE 801A may identify a packet as a sensing-related packet by at least one of the following: an indication in a PDCP format for the packet indicates that the packet is a sensing-related packet; or an LCID associated with the packet is specific for a sensing-related packet.

In some embodiments of the present disclosure, the priority of a logical channel for carrying the sensing measurement report may be predefined, may be the same or different from that of a logical channel for carrying a non-sensing-related service, or may be determined according to a sensing service requirement. For example, the logical channel priority of the sensing measurement report may be the same as the current SL SRBs, for example, setting as priority value=1. For example, the logical channel priority of the sensing measurement report may be different from the current SL SRB, for example, setting as priority value>1. For example, various priority values can be set for the logical channel of the sensing measurement report, depending on the requirement for the corresponding sensing service. As described above, a mapping table may be maintained at UE 801A for determining the suitable priority value.

It should be appreciated by persons skilled in the art that the sequence of the operations in exemplary procedure 800 may be changed and some of the operations in exemplary procedure 800 may be eliminated or modified, without departing from the spirit and scope of the disclosure.

FIG. 9 illustrates a flow chart of an exemplary procedure 900 for sidelink based sensing in accordance with some embodiments of the present disclosure. Details described in all of the foregoing embodiments of the present disclosure are applicable for the embodiments shown in FIG. 9. In some examples, the procedure may be performed by a UE.

Referring to FIG. 9, in operation 911, a UE (denoted as “first UE” for clarity) may receive, from an upper layer of the first UE, a BS or a network node, a request to perform a PC5 based sensing. In some embodiments of the present disclosure, the network node may be an AMF or an SF.

In operation 913, the first UE may perform the PC5 based sensing with another UE (denoted as “second UE” for clarity) in response to the request to perform the PC5 based sensing.

In some embodiments of the present disclosure, performing the PC5 based sensing may include at least one of the following: transmitting a sensing RS to the second UE via a PC5 interface between the first UE and the second UE; receiving a measurement result related to the sensing RS from the second UE; or receiving a sensing RS from the second UE via the PC5 interface.

In some embodiments of the present disclosure, the first UE may establish a PC5 RRC connection with the second UE in response to the request to perform the PC5 based sensing, wherein the PC5 RRC connection is specific for the PC5 based sensing.

In some embodiments of the present disclosure, establishing the PC5 RRC connection may include transmitting, to the second UE, a request to establish the PC5 RRC connection separated from an existing PC5 RRC connection between the first UE and the second UE. The request to establish the PC5 RRC connection may include an indication indicating the existing PC5 RRC connection. In some embodiments of the present disclosure, the indication indicates a pair of a source ID and a destination ID of the existing PC5 RRC connection.

In some embodiments of the present disclosure, the PC5 RRC connection may be associated with a destination ID specific for the PC5 based sensing.

In some embodiments of the present disclosure, the first UE may perform at least one of the following: transmit, to the second UE, area information indicating an area in which the PC5 based sensing is to be performed; or receive a leaving indication from the second UE, wherein the leaving indication is based on the area information.

In some embodiments of the present disclosure, the first UE may determine whether to release a PC5 link between the first UE and the second UE based on the leaving indication; or transmit, to the second UE, a release message to release the PC5 link between the first UE and the second UE in response to receiving the leaving indication.

In some embodiments of the present disclosure, the first UE may transmit, to the second UE, at least one trigger condition for a sensing measurement report. In some embodiments of the present disclosure, the at least one trigger condition may include at least one of the following: a pose change of an object of interest; a threshold for the number of objects of interest within a period; or a threshold for a channel quality change of a channel between the first UE and the second UE.

In some embodiments of the present disclosure, the first UE may transmit a packet related with the PC5 based sensing to the second UE. Transmitting the packet related with the PC5 based sensing may include at least one of the following: transmitting, to the second UE, a PDCP packet including an indication indicating that the packet is a sensing-related packet; or transmitting the packet related with the PC5 based sensing using a logical channel ID specific for a sensing-related packet.

In some embodiments of the present disclosure, the first UE may receive a sensing measurement report from the second UE. Receiving the sensing measurement report may include identifying a packet corresponding to the sensing measurement report as a sensing-related packet by at least one of the following: an indication in a PDCP format for the packet corresponding to the sensing measurement report indicates that the packet is a sensing-related packet; or a logical channel ID associated with the packet corresponding to the sensing measurement report is specific for a sensing-related packet.

In some embodiments of the present disclosure, the indication may be an SDU type specific for sensing-related packet or is a reserved bit.

In some embodiments of the present disclosure, a priority of a logical channel for carrying the packet related with the PC5 based sensing or the sensing measurement report may be predefined, may be the same or different from that of a logical channel for carrying a non-sensing-related service, or may be determined according to a sensing service requirement.

In some embodiments of the present disclosure, a PC5 interface between the first UE and the second UE may include a sensing layer, which is located above a PDCP layer, an SDAP layer, a PC5-S layer, or an RRC layer of the PC5 interface.

It should be appreciated by persons skilled in the art that the sequence of the operations in exemplary procedure 900 may be changed and some of the operations in exemplary procedure 900 may be eliminated or modified, without departing from the spirit and scope of the disclosure.

FIG. 10 illustrates a flow chart of an exemplary procedure 1000 for sidelink based sensing in accordance with some embodiments of the present disclosure. Details described in all of the foregoing embodiments of the present disclosure are applicable for the embodiments shown in FIG. 10. In some examples, the procedure may be performed by a UE.

Referring to FIG. 10, in operation 1011, a UE (denoted as “second UE” for clarity) may receive a configuration for a PC5 based sensing from another UE (denoted as “first UE” for clarity). In operation 1013, the second UE may perform the PC5 based sensing with the first UE in response to receiving the configuration.

In some embodiments of the present disclosure, performing the PC5 based sensing may include at least one of the following: receiving a sensing RS from the first UE via a PC5 interface between the first UE and the second UE; transmitting a measurement result related to the sensing RS to the first UE; or transmitting a sensing RS to the first UE via the PC5 interface.

In some embodiments of the present disclosure, the second UE may establish a PC5 RRC connection between the first UE and the second UE, wherein the PC5 RRC connection is specific for the PC5 based sensing.

In some embodiments of the present disclosure, establishing the PC5 RRC connection may include receiving, from the first UE, a request to establish the PC5 RRC connection separated from an existing PC5 RRC connection between the first UE and the second UE. The request to establish the PC5 RRC connection may include an indication indicating the existing PC5 RRC connection. In some embodiments of the present disclosure, the indication may indicate a pair of a source ID and a destination ID of the existing PC5 RRC connection.

In some embodiments of the present disclosure, the PC5 RRC connection may be associated with a destination ID specific for the PC5 based sensing.

In some embodiments of the present disclosure, the second UE may perform at least one of the following: receive, from the first UE, area information indicating an area in which the PC5 based sensing is to be performed; or transmit a leaving indication to the first UE when the second UE leaves the area.

In some embodiments of the present disclosure, the second UE may receive, from the first UE, a release message to release a PC5 link between the first UE and the second UE in response to the leaving indication.

In some embodiments of the present disclosure, the second UE may receive, from the first UE, at least one trigger condition for a sensing measurement report. In some embodiments of the present disclosure, the at least one trigger condition may include at least one of the following: a pose change of an object of interest; a threshold for the number of objects of interest within a period; or a threshold for a channel quality change of a channel between the first UE and the second UE.

In some embodiments of the present disclosure, the second UE may identify a packet related with the PC5 based sensing as a sensing-related packet by at least one of the following: an indication in a packet data convergence protocol (PDCP) format for the packet related with the PC5 based sensing indicates that the packet is a sensing-related packet; or a logical channel ID associated with the packet related with the PC5 based sensing is specific for a sensing-related packet.

In some embodiments of the present disclosure, the second UE may transmit a sensing measurement report to the first UE. Transmitting the sensing measurement report may include at least one of the following: transmitting, to the first UE, a PDCP packet including an indication indicating that the packet is a sensing-related packet; or transmitting the sensing measurement report using a logical channel ID specific for a sensing-related packet.

In some embodiments of the present disclosure, the indication may be an SDU type specific for sensing-related packet or is a reserved bit.

In some embodiments of the present disclosure, a priority of a logical channel for carrying the packet related with the PC5 based sensing or the sensing measurement report may be predefined, may be the same or different from that of a logical channel for carrying a non-sensing-related service, or may be determined according to a sensing service requirement.

In some embodiments of the present disclosure, a PC5 interface between the first UE and the second UE may include a sensing layer, which is located above a PDCP layer, an SDAP layer, a PC5-S layer, or an RRC layer of the PC5 interface.

It should be appreciated by persons skilled in the art that the sequence of the operations in exemplary procedure 1000 may be changed and some of the operations in exemplary procedure 1000 may be eliminated or modified, without departing from the spirit and scope of the disclosure.

FIG. 11 illustrates a flow chart of an exemplary procedure 1100 for sidelink based sensing in accordance with some embodiments of the present disclosure. Details described in all of the foregoing embodiments of the present disclosure are applicable for the embodiments shown in FIG. 11. In some examples, the procedure may be performed by a network node.

Referring to FIG. 11, in operation 1111, a network node may transmit, to a BS, a request for a PC5 based sensing service. The request for the PC5 based sensing service may indicate at least one of the following: area information indicating an area in which the PC5 based sensing is to be performed; an accuracy requirement for the PC5 based sensing service; a number of UEs assisting a target UE to perform the PC5 based sensing service; or ID(s) of the target UE.

In operation 1113, the network node may receive, from the BS, a measurement result related to the PC5 based sensing service.

In some embodiments of the present disclosure, the network node may be an AMF. In some embodiments of the present disclosure, the network node may be an SF, and the request for the PC5 based sensing service may be transmitted to the BS via the AMF.

In some embodiments of the present disclosure, the number of UEs may be indicated as a value range, or indicated as a minimum number of UEs.

It should be appreciated by persons skilled in the art that the sequence of the operations in exemplary procedure 1100 may be changed and some of the operations in exemplary procedure 1100 may be eliminated or modified, without departing from the spirit and scope of the disclosure.

The above embodiments and procedures are directed to the sensing function. It should be appreciated by persons skilled in the art that these embodiments and procedures can also be applied to a positioning case (e.g., PC5 based positioning).

For instance, “positioning” can be deemed as a special case of “sensing.” For example, the above embodiments and procedures can be reused for positioning by simply replacing the term “sensing” with the term “positioning.” For instance, in the positioning case, a position-related measurement(s) instead of a sensing-related measurement(s) may be performed.

For example, the SF in the above embodiments and procedures may be replaced by another network node (e.g., location management function (LMF)). The LMF may transmit a request for PC5-based positioning of a target device to an AMF. Alternatively, the AMF may determine the request for positioning. The AMF may transmit the request for positioning to one or more BS.

The LTE Positioning Protocol (LPP) is terminated between a target device (a UE in the control-plane case or a secure user plane location (SUPL) enabled terminal (SET) in the user-plane case) and a positioning server (an LMF in the control-plane case or SUPL location platform (SLP) in the user-plane case). It may use either the control-plane or user-plane protocols as underlying transport. LPP defined data structures for assistance data information are reused for supporting RRC broadcast of assistance data information which are embedded in positioning system information blocks (SIBs). This enables broadcast assistance data using the same data structures which are used for point to point location. The LPP protocol data unit (PDU) is carried in a non-access stratum (NAS) PDU between the AMF and the UE.

The NR positioning protocol A (NRPPa) carries information between a next generation-radio access network (NG-RAN) node and the LMF. The NRPPa protocol is transparent to the AMF. The AMF routes the NRPPa PDUs transparently based on a routing ID corresponding to the involved LMF over the NG-control plane (NG-C) interface without knowledge of the involved NRPPa transaction. It carries the NRPPa PDUs over NG-C interface either in a UE associated mode or non-UE associated mode.

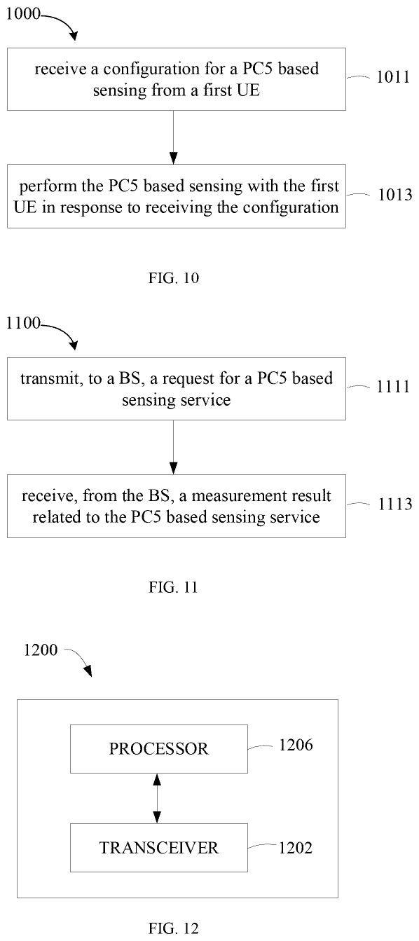

FIG. 12 illustrates a block diagram of an exemplary apparatus 1200 according to some embodiments of the present disclosure. As shown in FIG. 12, the apparatus 1200 may include at least one processor 1206 and at least one transceiver 1202 coupled to the processor 1206. The apparatus 1200 may be a UE, a BS, or a network node (e.g., an AMF, an SF, or an LMF).

Although in this figure, elements such as the at least one transceiver 1202 and processor 1206 are described in the singular, the plural is contemplated unless a limitation to the singular is explicitly stated. In some embodiments of the present application, the transceiver 1202 may be divided into two devices, such as a receiving circuitry and a transmitting circuitry. In some embodiments of the present application, the apparatus 1200 may further include an input device, a memory, and/or other components.

In some embodiments of the present application, the apparatus 1200 may be a UE. The transceiver 1202 and the processor 1206 may interact with each other so as to perform the operations with respect to the UE described in FIGS. 1-11. In some embodiments of the present application, the apparatus 1200 may be a BS. The transceiver 1202 and the processor 1206 may interact with each other so as to perform the operations with respect to the BS described in FIGS. 1-11. In some embodiments of the present application, the apparatus 1200 may be a network node. The transceiver 1202 and the processor 1206 may interact with each other so as to perform the operations with respect to the network node described in FIGS. 1-11.

In some embodiments of the present application, the apparatus 1200 may further include at least one non-transitory computer-readable medium.

For example, in some embodiments of the present disclosure, the non-transitory computer-readable medium may have stored thereon computer-executable instructions to cause the processor 1206 to implement the method with respect to the UE as described above. For example, the computer-executable instructions, when executed, cause the processor 1206 interacting with transceiver 1202 to perform the operations with respect to the UE described in FIGS. 1-11.

In some embodiments of the present disclosure, the non-transitory computer-readable medium may have stored thereon computer-executable instructions to cause the processor 1206 to implement the method with respect to the BS as described above. For example, the computer-executable instructions, when executed, cause the processor 1206 interacting with transceiver 1202 to perform the operations with respect to the BS described in FIGS. 1-11.

In some embodiments of the present disclosure, the non-transitory computer-readable medium may have stored thereon computer-executable instructions to cause the processor 1206 to implement the method with respect to the network node as described above. For example, the computer-executable instructions, when executed, cause the processor 1206 interacting with transceiver 1202 to perform the operations with respect to the network node described in FIGS. 1-11.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A first user equipment (UE) for wireless communication, comprising:
at least one memory; and
at least one processor coupled with the at least one memory and configured to cause the first UE to:
receive, from an upper layer of the first UE, a base station (BS), or a network node, a request to perform a PC5 based sensing; and
perform the PC5 based sensing with a second UE in response to the request to perform the PC5 based sensing.

2. The first UE of claim 1, wherein the at least one processor is configured to cause the first UE to perform the PC5 based sensing by:
transmitting a sensing reference signal (RS) to the second UE via a PC5 interface between the first UE and the second UE;
receiving a measurement result related to the sensing RS from the second UE; or
receiving a sensing RS from the second UE via the PC5 interface.

3. The first UE of claim 1, wherein the at least one processor is further configured to cause the first UE to establish a PC5 radio resource control (RRC) connection with the second UE in response to the request to perform the PC5 based sensing, wherein the PC5 RRC connection is specific for the PC5 based sensing.

4. The first UE of claim 3, wherein the at least one processor is configured to cause the first UE to: establish the PC5 RRC connection by transmitting, to the second UE, a request to establish the PC5 RRC connection separated from an existing PC5 RRC connection between the first UE and the second UE; and
wherein the request to establish the PC5 RRC connection comprises an indication indicating the existing PC5 RRC connection.

5. The first UE of claim 4, wherein the indication indicates a pair of a source ID and a destination ID of the existing PC5 RRC connection.

6. The first UE of claim 3, wherein the PC5 RRC connection is associated with a destination ID specific for the PC5 based sensing.

7. The first UE of claim 1, wherein the at least one processor is further configured to cause the first UE toperform at least one of the following:
transmit, to the second UE, area information indicating an area in which the PC5 based sensing is to be performed; or
receive a leaving indication from the second UE, wherein the leaving indication is based on the area information.

8. The first UE of claim 7, wherein the at least one processor is further configured to cause the first UE to:
determine whether to release a PC5 link between the first UE and the second UE based on the leaving indication; or
transmit, to the second UE, a release message to release the PC5 link between the first UE and the second UE in response to receiving the leaving indication.

9. The first UE of claim 1, wherein the at least one processor is further configured to cause the first UE to transmit, to the second UE, at least one trigger condition for a sensing measurement report.

10. The first UE of claim 9, wherein the at least one trigger condition comprises at least one of the following:
a pose change of an object of interest;
a threshold for the number of objects of interest within a period; or
a threshold for a channel quality change of a channel between the first UE and the second UE.

11. The first UE of claim 1, wherein the at least one processor is further configured to cause the first UE to transmit a packet related with the PC5 based sensing to the second UE, and wherein transmitting the packet related with the PC5 based sensing comprises at least one of the following:
transmitting, to the second UE, a packet data convergence protocol (PDCP) packet including an indication indicating that the packet is a sensing-related packet; or
transmitting the packet related with the PC5 based sensing using a logical channel ID specific for a sensing-related packet.

12. The first UE of claim 1, wherein the at least one processor is further configured to cause the first UE to receive a sensing measurement report from the second UE, and wherein receiving the sensing measurement report comprises identifying a packet corresponding to the sensing measurement report as a sensing-related packet by at least one of the following:
an indication in a packet data convergence protocol (PDCP) format for the packet corresponding to the sensing measurement report indicates that the packet is a sensing-related packet; or
a logical channel ID associated with the packet corresponding to the sensing measurement report is specific for a sensing-related packet.

13. The first UE of claim 11, wherein the indication is a service data unit (SDU) type specific for sensing-related packet or is a reserved bit.

14. A second user equipment (UE) for wireless communication, comprising:
at least one memory; and
at least one processor coupled with the at least one memory and configured to cause the second UE to:
receive a configuration for a PC5 based sensing from a first UE; and
perform the PC5 based sensing with the first UE in response to receiving the configuration.

15. A network node for wireless communication, comprising:
at least one memory; and
at least one processor coupled with the at least one memory and configured to cause the network node to:
transmit, to a base station (BS), a request for a PC5 based sensing service, wherein the request for the PC5 based sensing service indicates at least one of the following:
area information indicating an area in which the PC5 based sensing is to be performed;
an accuracy requirement for the PC5 based sensing service;
a number of user equipment (UEs) assisting a target UE to perform the PC5 based sensing service; or
identifiers of the target UE; and
receive, from the BS, a measurement result related to the PC5 based sensing service.

16. The network node of claim 15, wherein the network node is an access and mobility management function (AMF); or
wherein the network node is a sensing function (SF), and the request for the PC5 based sensing service is transmitted to the BS via the AMF.

17. The network node of claim 15, wherein the number of UEs indicates as a value range or indicates as a minimum number of UEs.

18. A method performed by a first user equipment (UE), the method comprising:
receiving, from an upper layer of the first UE, a base station (BS), or a network node, a request to perform a PC5 based sensing; and
performing the PC5 based sensing with a second UE in response to the request to perform the PC5 based sensing.

19. The method of claim 18, wherein performing the PC5 based sensing includes:
transmitting a sensing reference signal (RS) to the second UE via a PC5 interface between the first UE and the second UE;
receiving a measurement result related to the sensing RS from the second UE; or
receiving a sensing RS from the second UE via the PC5 interface.

20. The method of claim 18, further comprising: establishing a PC5 radio resource control (RRC) connection with the second UE in response to the request to perform the PC5 based sensing, wherein the PC5 RRC connection is specific for the PC5 based sensing.
